(19) United States
(12) Patent Application Publication
(10) Pub. No.: US 2025/0236088 A1
(43) Pub. Date: Jul. 24, 2025

(54) COMPOSITE LAMINATE MATERIAL USING CORN STALK SEGMENTS

(71) Applicant: Mark Kenneth Neitzke, Waterford, MI (US)

(72) Inventor: Mark Kenneth Neitzke, Waterford, MI (US)

(21) Appl. No.: 19/031,739

(22) Filed: Jan. 18, 2025

Related U.S. Application Data
(60) Provisional application No. 63/622,607, filed on Jan. 19, 2024.

(51) Int. Cl. B32B 3/18; B32B 29/00

(52) U.S. Cl. CPC B32B 3/18; B32B 29/002; B32B 29/005; B32B 2250/40; B32B 2307/54

(57) ABSTRACT

A laminate composite structure is disclosed comprising a first laminate sheet having transverse sections of corn stalk affixed at a first surface of the sections to a first surface of the first laminate sheet and a second laminate sheet arranged affixed to a second opposed surface of the transverse corn stalk sections.

### CROSS-REFERENCE TO RELATED APPLICATIONS

This application claims the benefit of U.S. Provisional Application No. 63/622,607, filed Jan. 19, 2024, pursuant to 35 U.S.C. § 119(e), which is expressly incorporated herein in its entirety.

### TECHNICAL FIELD

Packaging and laminate materials such as cardboard have been known for many years. Basically, the composite cardboard material is two layers of cardboard with a third layer arranged in a sinusoidal or wave configuration corrugation between the two layers. A more structural form of cardboard has the core arranged in a vertical/honeycomb orientation. This increased strength is more expensive to manufacture. The structure is glued or adhered together and provides a packaging material with a rigidity that is suitable for commercial use.

The standard cardboard packaging material uses paper made from tree pulp, or other organic sources. Those skilled in the art also recognize that plastic configurations for packaging material are also available. The necessary processes to convert trees to paper, or other plant based raw materials into usable sheet stock, require a cost input into the finished product. During this processing, the manufacturing machinery disrupts the organic structure of the tree/plant as nature has designed its structure to grow, converting it to base elements more conducive to downstream processing. All of this changing of state from nature to end use makes the raw material denser. One disadvantage of standard cardboard products is that paper composite material suffers from weakness when it is wet, or when it subjected to a force transverse to the longitudinal surface of the carboard that bends the cardboard composite. Once bent, the cardboard composite loses its structural rigidity in the longitudinal direction. When the conventional paper cardboard is wet, it is easily crushed flat, or if the laminate structure is adhered together with an aqueous adhesive, may even delaminate into its constituent layers.

There is economic and strength-to-weight opportunity available for cardboard when the corrugation/core layer is replaced with materials employed in the natural state as grown in nature. There is a need for an economical, strong, lightweight, composite laminate packaging material that retains its structural integrity when wet and further is not subject to structural integrity issues when it is longitudinally bent.

### SUMMARY

In one embodiment, there is disclosed herein a composite laminate packaging material that is economical, lightweight, strong and resists loss of structural integrity when wetted. It has been found that corn stalks, and other plants having stalks with a rind and pith, such as jute, hemp, sisal, kenaf, sunflower sorghum and burdock, when properly handled and arranged on a laminate material, may be used as the core structural component of a composite packaging material. In this disclosure, corn stalks are discussed, but any plant having a stalk with a rind and pith are included in the disclosure.

For example, corn stalks are usually discarded or turned to mulch during the faming/harvesting process. When a portion of the corn stalk is cut transversely into a length of segments terminating in opposed ends, such segments can be oriented into longitudinal bundles and gathered for further processing. The corn stalk segments are cut transversely into segments of a desired thickness to create a plurality of corn stalk transverse segments having a rind or dermal layer surrounding the pith or ground tissue and the vascular tissue of the corn stalk. By the term transverse or transversely cut, it is meant that the plant stalk may be cut in any way that is not a longitudinal cut.

In plants having a stalk with a rind and a pith, such as a corn plant, the rind is stiffer than the pith. When the stalk is transversely cut into corn stalk segments, the rind and pith are exposed. The pith will absorb water more than the rind portion of the corn stalk segment. It has been determined that these transversely cut corn stalk segments may be glued or affixed to a laminate material such as paper, woven and non-woven fabric, gypsum board, or vinyl, by way of glue applied to the adjoining surfaces of the laminate. In this natural state of arrangement, all the transversely cut corn stalk segments (transverse segments) are capturing the simplistic efficiency developed through evolution that has produced this columnar load bearing structure. Being arranged in the same direction, the stalk segment is secured to the laminate and the pith is in facing engagement with the laminate material. The adhesive may be applied to the transverse segments, laminate, or both. The transverse segments of corn may be touching each other along some portion of their respective rinds, or it may be that the transverse segments are separate from each other, depending upon the structural strength desired for the laminate so produced. A second laminate sheet having a glue or adhesive applied thereon is then applied over the exposed pith surface of the transverse segments and placed on the exposed pith surface. The laminate so formed may be subjected to a mild pressing to assure firm adhesion of the glued laminates to the pith surfaces and allowed to dry/cure. It has been determined that packaging materials and containers, furniture, building structural materials, recreational vehicles, commercial and passenger vehicles may be made using the materials and methods described herein.

### BRIEF DESCRIPTION OF DRAWINGS

The description herein makes reference to the accompanying drawings wherein like reference numerals refer to like parts throughout the several views, and wherein:

FIG. 1 is schematic representation of a row of corn plants standing in a field;

FIG. 2 is a schematic representation of a harvesting machine cutting a segment of the corn stalk to process into the composite laminate;

FIG. 3 is a sectional view of a segment of a corn stalk wherein the leaves are removed, and the stalk is cut into a predetermined length for further processing;

FIG. 4 is a perspective transverse view of a segment of cornstalk cut from the stalk of FIG. 3, showing the rind, the pith and the vascular tissue;

FIG. 5 is a perspective view of a laminate material having glue applied to one of its surfaces;

FIG. 6 is a perspective view of a plurality of transverse corn stalk segments arranged on the surface of a laminate material;

FIG. 7 is a perspective view of a composite laminate formed according to one aspect of the present disclosure wherein the corn stalk transverse segments are glued between two laminate sheets.

### DETAILED DESCRIPTION

Referring now to the discussion that follows and also to the drawings, illustrative approaches to the disclosed systems and methods are described in detail. Although the drawings represent some possible approaches, the drawings are not necessarily to scale and certain features may be exaggerated, removed, or partially sectioned to better illustrate and explain the present invention. Further, the descriptions set forth herein are not intended to be exhaustive or otherwise limit or restrict the claims to the precise forms and configurations shown in the drawings and disclosed in the following detailed description.

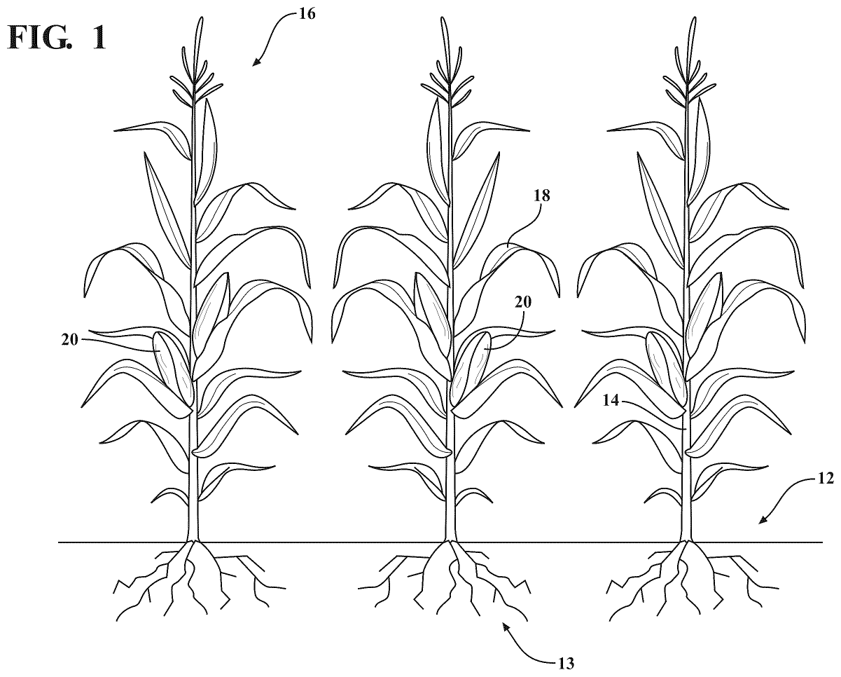

FIG. 1 is a representational side view of a row of corn plants 10 in a field 12. Describing only one such plant with the understanding that all the corn plants have the same or similar structure, the stalk 14 extends from the root system, 13 in the ground, and terminates at its opposite end with the tassel 16. Between the roots and the tassel, the stalk supports a plurality of leaves 18 with a corn cob 20 growing from the joint of the leaf and the stalk.

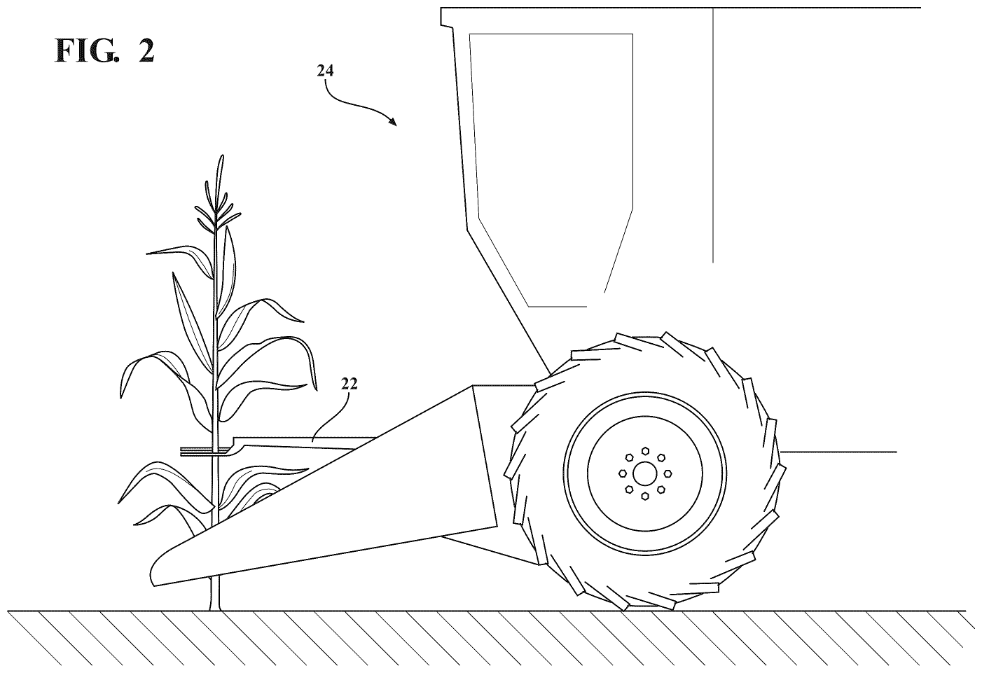

FIG. 2 is a representational view of a corn stalk harvesting machine 22 which may be an add on to existing corn harvester machines 24. The corn stalk harvesting machine may be a cutter positioned a predetermined height from the ground so the machine cuts those portions of the corn plant that are not expected to have a corn cob. In another embodiment. The corn stalk harvester is internal to the corn harvesting machine, and as the corn harvesting machine strips the corn and the leaves from the corn stalk, the corn stalk harvesting machine cuts the corn stalk into predetermined lengths and ejects them from the corn harvesting machine such that the are all oriented in one direction for ease of further gathering and processing. In another embodiment, the corn stalk segments are bundled together such that they are oriented in the same direction.

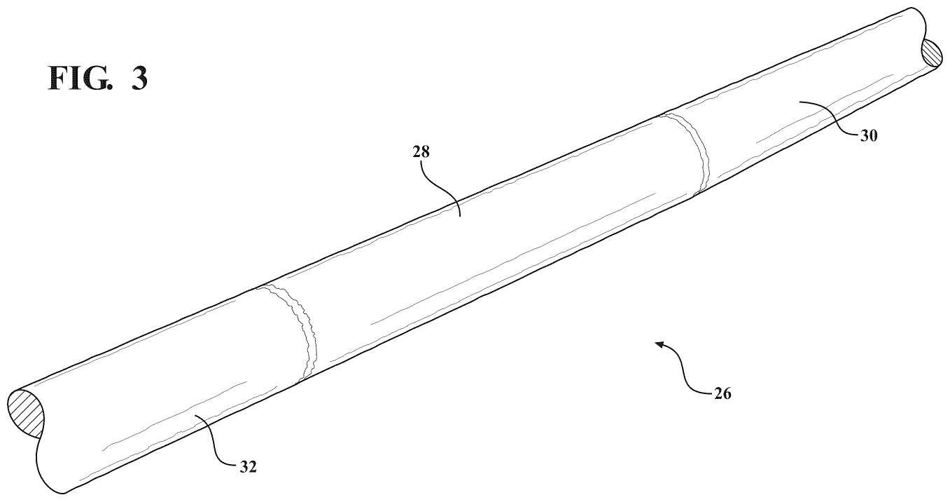

FIG. 3 is a perspective view of a segment of a corn stalk that has been cut to a predetermined length. In one embodiment according to the present disclosure, the corn stalk segment 26 may include an intermodal segment 28 terminating in opposed modal segments 30 and 32, respectively. It is understood that the intermodal length may be several intermodal segments. The corn stalk segment is subjected to a cutting in the transverse direction.

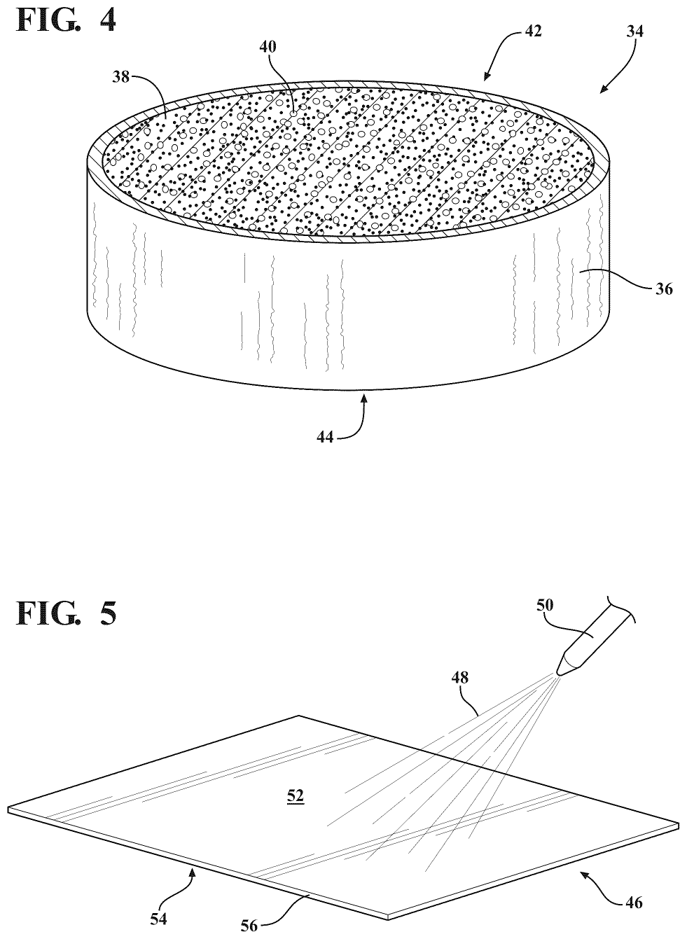

FIG. 4 is perspective side view of one transverse segment 34 of the corn stalk, showing its anatomy. The rind or dermal tissue 36 is the outermost layer of the corn stalk and surrounds the pith or ground tissue 38 and the vascular tissue 40. The transverse section of the corn stalk has a first surface 42 and an opposed second surface 44. The longitudinal modulus of the rind is a very important material property because it bears the vast majority of bending, axial and torsional loads.

FIG. 5 is a perspective view of a laminate sheet 46 having glue 48 or other adhesive applied to one of its surfaces 52 by a spray apparatus 50. Those in the art will also appreciate that roll coating may also be used. It is contemplated that any manner of applying the glue or adhesive may be used to coat the surface of the laminate with glue. The glue may be aqueous, or water based, or may be petroleum, epoxy or other chemical-based glues, depending upon the needs of the user.

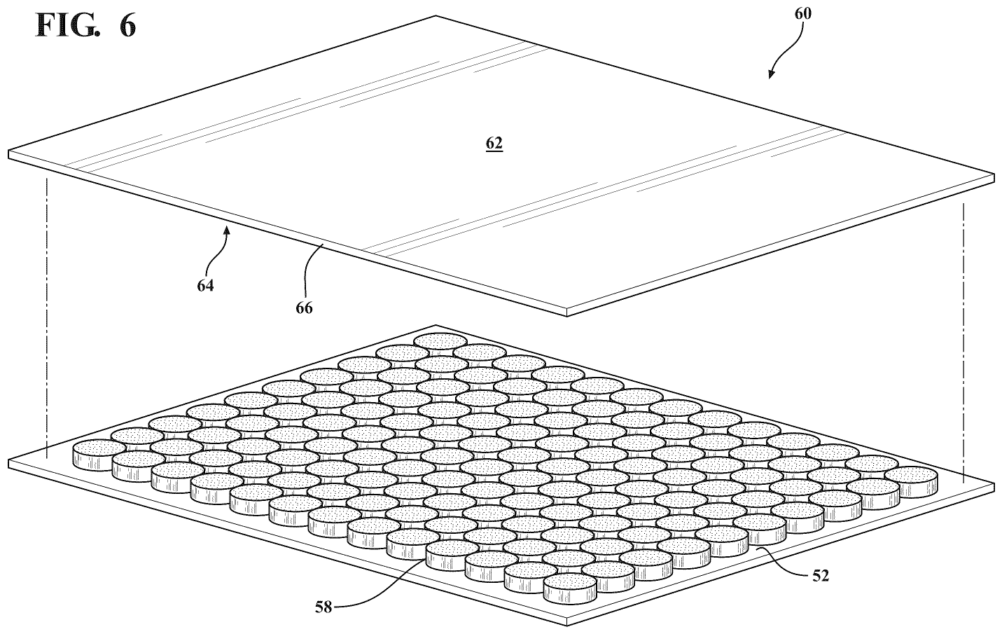

FIG. 6 is a perspective schematic representation of a laminate sheet having transverse segments of corn stalk arranged on one of its surfaces. The laminate sheets as discussed in this disclosure may have a similar structure to each other. Specifically, laminate sheet 46 has opposed surfaces 52 and 54 separated by a sidewall 56 extending substantially unbroken therebetween to form a laminate sheet. As seen from FIG. 5, an adhesive or glue 48 suitable to the needs of the user is applied to surface 52, and the transverse corn stalk segments are arranged on the surface 52 with a planar surface 42 or 44 in contact with the glue or adhesive such that the corn stalk segment becomes adhered to the surface 52 of the laminate. In this arrangement, it is shown that all the segments are touching at some point 58 along their respective rinds. It is understood that in other arrangements of the transverse corn stalk segments along surface 52, the transverse corn stalk segments are spaced apart such that some of the rind surfaces may be in contact with each other, whereas others are not. Or it may be that none of the rind surfaces are in contact with each other. By varying the number of the transverse corn segments on the surface 52 of the laminate sheet, one may vary the mechanical properties of the composite sheet that will be formed when laminate sheet 60 of the same or similar structure as laminate sheet 46, having opposed faces 62 and 64 separated by a sidewall 66 to form a laminate sheet.

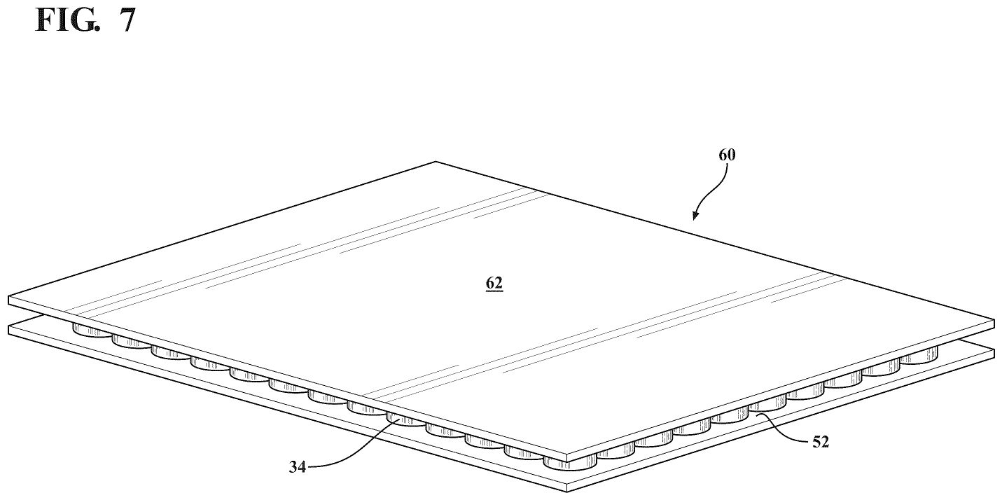

FIG. 7 shows one embodiment of a composite laminate structure according to one aspect of this disclosure. Specifically, glue or adhesive may be applied to the planar surface of the transverse corn stalk segments on sheet surface 52, or surface 64 of the laminate sheet 60 may have glue applied to it as described in FIG. 5. Laminate sheet 60 is then pressed to the surface of the transverse corn stalks and allowed to dry, forming a composite laminate structure of improved strength when compared to cardboard.

Those skilled in the art recognize many variations and modifications may be made without departing from the scope of the invention as set forth in the claims.

1. A laminate composite structure comprising first and second laminate sheets, each laminate sheet having opposed surfaces separated by a sidewall extending therebetween; surfaces; having transverse sections of plant stalks comprised of rind and pith affixed at a first surface of the sections to a first surface of the first laminate sheet and a second laminate sheet arranged affixed to a second opposed surface of the transverse plant stalk sections.

2. The laminate composite structure of claim 1, wherein multiple plant stalk segments are arranged transversely on the laminate sheet surface.

3. The laminate composite structure of claim 1, wherein the plant stalk segments arranged such that the rind portions of adjacent plant stalk segments touch each other.

4. The laminate composite structure of claim 1, wherein there are additional laminate sheets affixed to the first sheet(s).

5. The laminate composite structure of claim 1, wherein there are multiple layers of the laminate composite.

6. The laminate composite structure of claim 4, wherein there are multiple layers of the laminate composite.
